(19) United States
(12) Patent Application Publication
(10) Pub. No.: US 2011/0317886 A1
(43) Pub. Date: Dec. 29, 2011

(54) INFORMATION PROCESSING APPARATUS

(75) Inventor: Yoshio Matsuoka, Ome-shi (JP)

(73) Assignee: KABUSHIKI KAISHA TOSHIBA, Tokyo (JP)

(21) Appl. No.: 13/171,038

(22) Filed: Jun. 28, 2011

(30) Foreign Application Priority Data
Jun. 28, 2010 (JP) 2010-146941

(51) Int. Cl. G06K 9/00

(52) U.S. Cl. 382/124

(57) ABSTRACT

According to one embodiment, an information processing apparatus includes a housing, a fingerprint sensor, a finger detecting module, an authenticating module, and an activating module. The fingerprint sensor is provided in a top surface of the housing and configured to take a fingerprint image. The finger detecting module is spaced from the fingerprint sensor by a certain distance and is configured to detect a finger. The authenticating module is configured to cause the fingerprint sensor to take a fingerprint image when the finger detecting module detects a finger. The authenticating module is also configured to determine whether authentication has succeeded or failed based on fingerprint data obtained from the fingerprint image. The activating module is configured to boot the information processing apparatus if the authenticating module determines that the authentication has succeeded.

### CROSS REFERENCE TO RELATED APPLICATION(S)

This application is based upon and claims the benefit of priority from Japanese Patent Application No. 2010-146941 filed on Jun. 28, 2010, the entire contents of which are incorporated herein by reference.

### FIELD

Embodiments described herein relates generally to an information processing apparatus which performs authentication processing.

### BACKGROUND

In recent years, to prevent leakage of secret information, security measures have been taken in information processing apparatus. One security function of related-art information processing apparatus is to perform authentication using a vein pattern of a finger.

In information processing apparatus which perform authentication using a vein pattern of a finger, various improvements have been made so far to have a finger placed at a correct position with respect to a camera in shooting a vein pattern of the finger. For example, a technique is known which allows a finger to be placed at the same position with respect to a camera for shooting a vein pattern of a finger as at the time of registration utilizing an action of slide-opening a shutter of the camera or an action of pressing a particular key of a keyboard or an additional switch.

As described above, in related-art information processing apparatus, a user is required to do a particular action as mentioned above in making authentication.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 shows an exemplary appearance of a personal computer according to an embodiment;

FIG. 2 is an exemplary functional block diagram of the personal computer according to the embodiment;

FIG. 3 is an exemplary sectional view of an information processing apparatus when fingerprint authentication according to the embodiment is performed;

FIGS. 4A and 4B illustrate an exemplary swipe action which is performed in the fingerprint authentication according to the embodiment;

FIG. 5 is an exemplary flowchart of the fingerprint authentication process according to the embodiment; and

FIG. 6 shows an exemplary appearance of a film-type fingerprint sensor as a modification to the embodiment.

### DETAILED DESCRIPTION

In general, according to one embodiment, an information processing apparatus includes a housing, a fingerprint sensor, a finger detecting module, an authenticating module, and an activating module. The fingerprint sensor is provided in a top surface of the housing and configured to take a fingerprint image. The finger detecting module is spaced from the fingerprint sensor by a certain distance and is configured to detect a finger. The authenticating module is configured to cause the fingerprint sensor to take a fingerprint image when the finger detecting module detects a finger. The authenticating module is also configured to determine whether authentication has succeeded or failed based on fingerprint data obtained from the fingerprint image. The activating module is configured to boot the information processing apparatus if the authenticating module determines that the authentication has succeeded.

Various embodiments will be hereinafter described with reference to the accompanying drawings.

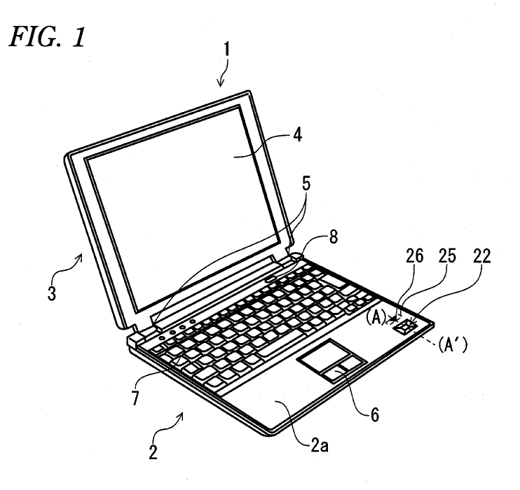

FIG. 1 shows an appearance of an information processing apparatus according to an embodiment which is a personal computer 1.

In the personal computer 1, a computer main body 2 and a display unit 3 are connected by hinges 5 so as to be rotatable with respect to each other. The computer main body 2 is equipped with a touch pad 6, a keyboard 7, a power switch 8, and a fingerprint sensor 22. The display unit 3 is equipped with a display 4 at the center.

In the embodiment, the top, bottom, left, right, front side, and rear side are defined as viewed by the user who uses the personal computer 1 while facing the display 4.

The display 4 displays video based on a video signal which is supplied from a graphic chip which is mounted on a board. The display 4 is an LCD (liquid crystal display), for example.

The top surface of a main body housing 2a is provided with operation devices such as the touch pad 6 and the keyboard 7, and the main body housing 2a houses boards, an HDD (hard disk drive) 16, etc. A palm rest of the main body housing 2a is provided with the fingerprint sensor 22, and a finger position mark 26 is formed about 1 cm in the rear of the fingerprint sensor 22. A finger detecting member 25 is disposed in the main body housing 2a at such a position as to correspond to the finger position mark 26.

The fingerprint sensor 22 has a shape and a color that are not conspicuous to the user. For example, the surface of the fingerprint sensor 22 is colored black when the main body housing 2a is black and the fingerprint sensor 22 is made flat so as not to project or be recessed much with respect to a neighboring portion of the main body housing 2a.

On the other hand, the finger position mark 26 which is formed in the rear of the fingerprint sensor 22 is formed so as to be conspicuous than the main body housing 2a. For example, the finger position mark 26 is given a different color than the main body housing 2a and is made a triangular arrow as a mark showing the user a position where to place a finger to make fingerprint authentication, that is, a fingerprint authentication start position.

Since as described above the fingerprint sensor 22 is provided integrally with the main body housing 2a and the finger position mark 26 is formed so as to be conspicuous than the main body housing 2a, the user would perform a swipe action (i.e., an action to cause the fingerprint sensor 22 to read a fingerprint of the user) after placing his or her finger so that its bulb faces the finger position mark 26 which is conspicuous. In other words, the user would feel as if a fingerprint authentication device existed at the position of the finger position mark 26 which attracts attention of the user; as such, the finger position mark 26 serves as a dummy fingerprint sensor. Where as described above the finger position mark 26 is formed in the rear of the fingerprint sensor 22, a swipe action is started in a state that the first joint of a finger is placed over the fingerprint sensor 22, whereby a fingerprint image of a wide range (from the first joint to the tip) of the finger can be taken.

The finger position mark 26 may be displayed with illumination by an LED 31 disposed under a transparent member that fills in a hole formed through the main body housing 2a. The finger position mark 26 can thus be made more conspicuous.

The lighting mode (color or flashing interval) of the LED 31 may be varied. That is, the lighting mode may be controlled according to the current status to show, for example, that a fingerprint sensor IC has been activated and the personal computer 1 is waiting for placement of a finger or that fingerprint authentication has succeeded or failed. For example, the user can be notified of a status of fingerprint authentication by continuously lighting the LED 31 in green in a finger placement standby state, flashing the LED 31 in green when fingerprint authentication has succeeded, and flashing the LED 31 in red when fingerprint authentication has failed. In this manner, the finger position mark 26 using the LED 31 can show the user not only the finger placement position but also a fingerprint authentication status.

The touch pad 6 is a pointing device provided in the top surface of the main body housing 2a. When the touch pad 6 is operated, an operation signal that commands an inter-picture transition, icon selection, or the like is supplied to individual modules.

The keyboard 7 is an input device provided in the top surface of the main body housing 2a. When a button of the keyboard 7 is operated, an operation signal that, for example, indicates input of a character or commands icon selection is supplied to individual modules.

When the power switch 8 is operated by the user, a control signal for powering on or off the personal computer 1 is input.

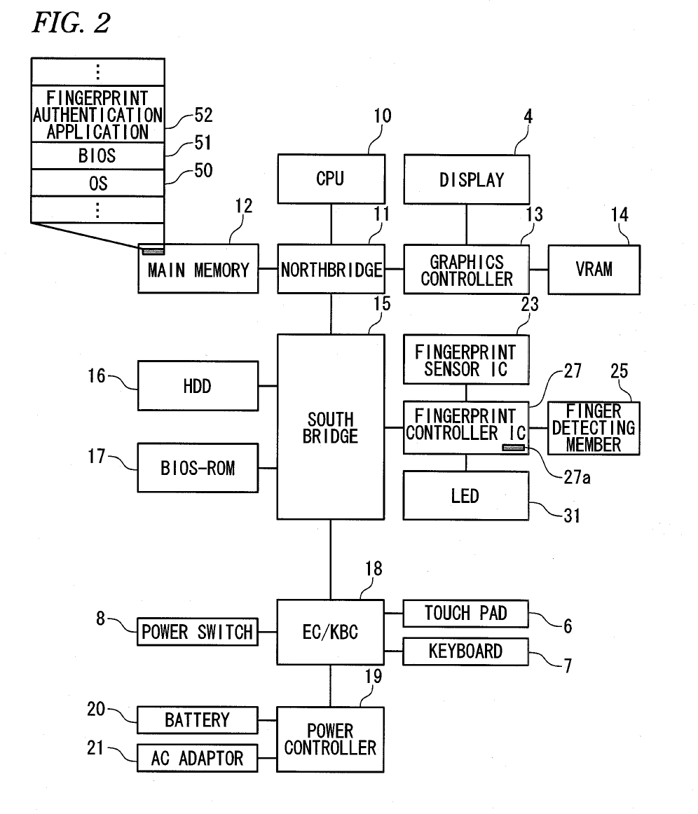

Next, functions of the personal computer 1 will be described with reference to FIG. 2. FIG. 2 is a functional block diagram of the personal computer 1 according to the embodiment.

The personal computer 1 is composed of the display 4, the touch pad 6, the keyboard 7, the power switch 8, a CPU 10, a northbridge 11, a main memory 12, a graphics controller 13, a VRAM 14, a southbridge 15, the HDD 16, a BIOS-TOM 17, an EC/KBC 18, a power controller 19, a battery 20, an AC adaptor 21, the fingerprint sensor IC 23, the finger detecting member 25, a fingerprint controller IC 27, a flash memory 27a, the LED 31, etc.

The CPU 10, which is a processor provided to control operations of the personal computer 1, runs an operating system (OS) 50 and various application programs when they are loaded into the main memory 12 from the HDD 16. The CPU 10 also runs a system BIOS 51 when it is loaded into the main memory 12 from the BIOS-ROM 17. The system BIOS 51 is a hardware control program. In booting the personal computer 1, the CPU 10 performs authentication by executing a fingerprint authentication application 52.

The northbridge 11 is a bridge device for connecting a local bus of the CPU 10 to the south bridge 15. The northbridge 11 incorporates a memory controller for access-controlling the main memory 12. The northbridge 11 also has a function of performing a communication with the graphics controller 13 via an AGP (accelerated graphics port) bus or the like.

The main memory 12 is a working memory where the OS 50 and the various application programs stored in the HDD 16 and the system BIOS 51 stored in the BIOS-ROM 17 are to be developed.

The graphics controller 13 is a display controller for controlling the display 4 which is used as a display monitor of the personal computer 1. The graphics controller 13 generates a video signal of a display image to be displayed on the display 4 based on display data that is drawn in the VRAM 14 by the OS 50 and an application program.

The southbridge 15 controls access to the BIOS-ROM 17 and controls disc drives (I/O devices) such as the HDD 16 and an ODD (optical disc drive).

The HDD 16 is a storage device for storing the OS 50, the various application programs, etc.

The BIOS-ROM 17 is a rewritable nonvolatile memory for storing the system BIOS 51 which is a hardware control program.

The EC/KBC 18 controls the touch pad 6 and the keyboard 7 which are input modules. The EC/KBC 18 is a one-chip microcomputer which monitors and controls various devices (peripheral devices, sensors, a power circuit, etc.) irrespective of the system situation of the personal computer 1. The EC/KBC 18 has a function of cooperating with the power controller 19 to power on or off the personal computer 1 when the power switch 8 is operated by the user.

While external power is supplied via the AC adaptor 21, the power controller 19 generates system power to be supplied to the individual components (computer main body 2 and display unit 3) of the personal computer 1 using the external power supplied from the AC adaptor 21. While no external power is supplied via the AC adaptor 21, the power controller 19 generates system power to be supplied to the individual components of the personal computer 1 using the battery 20.

The fingerprint sensor IC 23 takes a fingerprint image of a finger that is swiped over the fingerprint sensor 22 and outputs it to the fingerprint controller IC 27. The fingerprint sensor IC 23 starts taking a fingerprint image as soon as the finger detecting member 25 detects the finger.

The finger detecting member 25, which is a conductor, is connected to a finger detection input pin of the fingerprint sensor IC 23. When a finger touches the finger position mark 26, the finger detecting member 25 detects a resulting potential variation and outputs it to the fingerprint sensor IC 23. The finger position mark 26 is formed on the main body housing 2a at such a position as to correspond to the finger detecting member 25. The finger position mark 26 may be in such a form as to be displayed with illumination by the LED 31. Where the LED 31 is used, the LED 31 is connected to and controlled by the fingerprint controller IC 27.

The fingerprint controller IC 27 performs authentication processing using a fingerprint image of the user which is input from the fingerprint sensor IC 23. For example, the fingerprint controller IC 27 is equipped with a USB controller and USB-connected to the fingerprint sensor IC 23. The fingerprint controller IC 27 is also equipped with the flash memory 27a which is stored with firmware incorporating user fingerprint data and a fingerprint authentication algorithm.

The flash memory 27a is stored with a setting (effective or ineffective) as to whether to perform fingerprint authentication and parameters etc. (hereinafter referred to as fingerprint data) indicating feature points of the fingerprint of a user to whom the use of the personal computer 1 should be permitted. If a setting to the effect that fingerprint authentication is effective is stored in the flash memory 27a, the fingerprint controller IC 27 performs authentication by extracting feature points from a fingerprint image of the user that is input from the fingerprint sensor IC 23 and comparing resulting fingerprint data with the fingerprint data that is registered in the flash memory 27a.

Having a general-purpose input/output port, the fingerprint controller IC 27 controls the LED 31 in the case where the finger position mark 26 uses the LED 31. More specifically, the fingerprint controller IC 27 lights the LED 31 in a form that is correlated with a status of the fingerprint sensor 22 by referring to information that is stored in the flash memory 27a and indicates correspondence between statuses of the fingerprint sensor 22 and lighting forms of the LED 31.

Example statuses of the fingerprint sensor 22 are a finger placement standby state in which the fingerprint sensor IC 23 has been activated but no finger has been detected by the finger detecting member 25, a fingerprint authentication success state in which coincidence has been found between a fingerprint image taken by the fingerprint sensor IC 23 and the registered fingerprint image, and a fingerprint authentication failure state in which coincidence has not been found between a fingerprint image taken by the fingerprint sensor IC 23 and the registered fingerprint image. Example lighting forms of the LED 31 that are correlated with the statuses of the fingerprint sensor 22 are as follows: the LED 31 is lit continuously in green in the finger placement standby state, flashed in green in the fingerprint authentication success state, and flashed in red in the fingerprint authentication failure state.

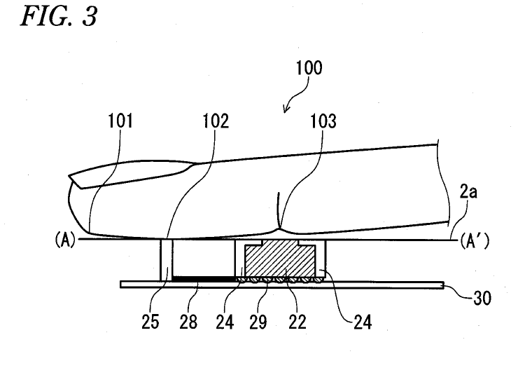

Next, a sectional structure of the personal computer 1 will be described with reference to FIG. 3, which is a sectional view of the personal computer 1 taken along line (A)-(A′) in FIG. 1 when fingerprint authentication according to the embodiment is performed.

As shown in FIG. 3, the user has fingerprint authentication started by placing his or her finger 100 on the finger position mark 26 which is formed on the main body housing 2a so as to be conspicuous. Since as described above the finger detecting member 25 is provided in the main body housing 2a at such a position as to correspond to the finger position mark 26, the finger detecting member 25 detects a potential variation when the finger 100 touches the finger position mark 26.

As shown in FIG. 3, the finger 100 has a tip portion 101, a bulb 102, and a first joint 103. When the user touches an object with the finger 100, usually the bulb 102 is brought into contact with the object first. The finger detecting member 25 and the fingerprint sensor 22 are spaced from each other by about 1 cm which is an average distance between the center of the bulb and the first joint of a finger.

The finger detecting member 25 is connected to the fingerprint sensor 22 by a conductor 28. The fingerprint sensor 22 is mounted on a printed circuit board 30 with solder balls 29.

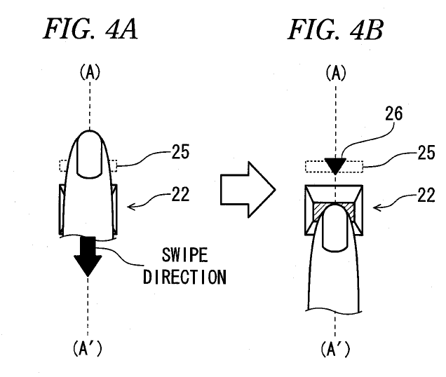

Next, how fingerprint authentication according to the embodiment is performed will be described with reference to FIGS. 4A and 4B. FIGS. 4A and 4B illustrate a swipe action which is performed in the fingerprint authentication according to the embodiment. FIG. 4A shows a state of a start of a swipe action, and FIG. 4B shows a state at a certain moment of the swipe action being performed.

First, a description will be made of the positional relationship between the fingerprint sensor 22 and the finger detecting member 25. The finger detecting member 25 is spaced rearward from the fingerprint sensor 22 by the certain distance, which is equal to the average distance (about 1 cm) between the center of the bulb and the first joint of a finger.

Next, a description will be made of a swipe action which is performed when fingerprint authentication is performed using the fingerprint sensor 22 and the finger detecting member 25 which are arranged in the above-described manner. First, as shown in FIG. 4A, if a setting is made that fingerprint authentication should be performed in booting the personal computer 1, the user places the bulb 102 of his or her finger 100 on the finger position mark 26 which is formed on the main body housing 2a so as to be conspicuous. As a result, the finger detecting member 25 which is disposed under the finger position mark 26 detects a potential variation. The finger detecting member 25 outputs the potential variation to the fingerprint sensor IC 23, and the fingerprint sensor IC 23 starts taking a fingerprint image. While the user places the bulb 102 of the finger 100 on the finger position mark 26, the first joint 103 is located over the fingerprint sensor 22.

Then, as shown in FIG. 4B, to cause fingerprint authentication, the user swipes the finger 100 toward the (A′) side, that is, toward the front side. As a result, the portion of the finger 100 from the first joint 103 to the tip portion 101 of the finger 100 passes over the fingerprint sensor 22. That is, the fingerprint sensor 22 can take a fingerprint image of the entire portion, located on the tip side of the first joint 103, of the finger 100.

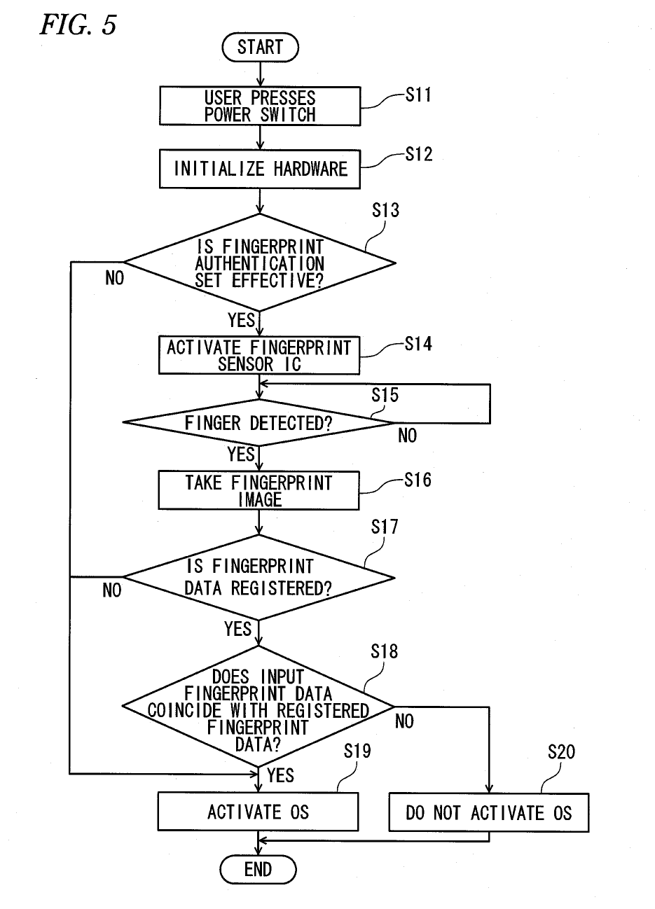

Next, a fingerprint authentication process according to the embodiment will be described with reference to FIG. 5. FIG. 5 is a flowchart of the fingerprint authentication process according to the embodiment.

First, at step S11, the user presses the power switch 8 of the personal computer 1. At step S12, the BIOS 51 initializes the hardware of the personal computer 1.

At step S13, the fingerprint controller IC 27 determines whether fingerprint authentication is set effective or not. In doing to, the fingerprint controller IC 27 reads the fingerprint authentication setting (effective or ineffective) from the flash memory 27a.

If fingerprint authentication is set effective (S13: yes), at step S14 the BIOS 51 activates the fingerprint sensor IC 23. On the other hand, if fingerprint authentication is set ineffective (S13: no), at step S19 the fingerprint controller IC 27 activates the OS 50 without performing fingerprint authentication.

Upon the activation of the fingerprint sensor IC 23, at step S15 the fingerprint controller IC 27 determines whether or not the finger detecting member 25 has detected a finger. That is, the fingerprint controller IC 27 determines whether or not the finger detecting member 25 which is connected to the fingerprint sensor 22 by the conductor 28 has detected a potential variation.

If the fingerprint controller IC 27 determines that the finger detecting member 25 has not detected a finger (S15: no), the process returns to step S15. That is, the fingerprint controller IC 27 is kept in a finger placement standby state until determining that a finger has been detected.

On the other hand, if the fingerprint controller IC 27 determines that the finger detecting member 25 has detected a finger (S15: yes), at step S16 the fingerprint sensor IC 23 starts taking a fingerprint image. Since the fingerprint sensor IC 23 starts taking a fingerprint image in a state that the bulb 102 of the finger 100 is placed over the finger detecting member 25, that is, the first joint 103 of the finger 100 is located over the fingerprint sensor 22, the fingerprint sensor IC 23 can take a fingerprint image of the entire portion, located on the tip side of the first joint 103, of the finger 100.

When receiving the fingerprint image from the fingerprint sensor IC 23, at step S17 the fingerprint controller IC 27 determines whether or not fingerprint data is registered in the flash memory 27a. If the fingerprint controller IC 27 determines that fingerprint data is not registered (S17: no), the process moves to step S19, where the OS 50 is activated. Fingerprint data is registered by the fingerprint authentication application 52.

On the other hand, if determining that fingerprint data is registered (S17: yes), at step S18 the fingerprint controller IC 27 determines whether or not fingerprint data indicating feature points of the input fingerprint image coincides with the registered fingerprint data. That is, the fingerprint controller IC 27 determines whether or not the user who is doing the fingerprint authentication has a legitimate use right. A method for determining whether or not fingerprint data of an input fingerprint image coincides with registered fingerprint data will not be described in detail. For example, whether or not a detected fingerprint coincides with a registered one can be determined by comparing them at several feature points.

If the fingerprint controller IC 27 determines that the fingerprint data of the input fingerprint image coincides with the registered fingerprint data (S18: yes), at step S19 the BIOS 51 activates the OS 50. On the other hand, if the fingerprint controller IC 27 determines that the fingerprint data of the input fingerprint image does not coincide with the registered fingerprint data (S18: no), at step S20 the BIOS 51 does not activate the OS 50. The fingerprint authentication process is thus finished.

In the embodiment, the user can set fingerprint authentication effective or ineffective in a switchable manner. A modification is possible in which fingerprint authentication is set ineffective as a default setting and is automatically made effective when a fingerprint is registered.

In the above-described embodiment, since the finger position mark 26 which urges the user to place his or her finger thereon is formed in the rear of the fingerprint sensor 22, the user who intends to do fingerprint authentication starts a swipe action after placing his or her finger 100 on the finger position mark 26. The finger detecting member 25 which is disposed at such a position as to correspond to the finger position mark 26 detects contact of the finger 100 based on a potential variation and the fingerprint sensor IC 23 starts taking a fingerprint image. Since the first joint 103 is located over the fingerprint sensor 22 in a state that the bulb 102 of the finger 100 is placed on the finger position mark 26, a fingerprint pattern can be taken starting from the first joint 103 of the finger 100. Therefore, a fingerprint image of a wider range can be taken and hence the registration ratio of a fingerprint image is increased.

If the finger position mark 26 were not formed, the user would start a swipe action in a state that the bulb 102 of his or her finger 100 is placed over the fingerprint sensor 22 and hence the fingerprint sensor IC 23 which is included in the fingerprint sensor 22 could take a fingerprint image of only a portion from the center of the bulb 102 to the tip portion 101 of the finger 100. In contrast, in the embodiment, since the finger position mark 26 is formed, the user starts a swipe action in a state that the first joint 103 of the finger 100 is located over the fingerprint sensor 22. Therefore, the fingerprint sensor IC 23 can take a fingerprint image of a portion from the first joint 102 to the tip portion 101 of the finger 100. As a result, according to the embodiment, not only the fingerprint registration ratio but also the fingerprint authentication success ratio is increased. That is, the probability of occurrence of an event that the fingerprint sensor 22 erroneously rejects a person who has a legitimate use right or erroneously accepts a person who does not have a legitimate use right.

Where the fingerprint sensor 22 has a suspension function, it takes a certain time to return to an ordinary operation state from a suspended state. If the finger position mark 26 were not formed, an ordinary operation state would be restored after the user places the bulb 102 of his or her finger 100 over the fingerprint sensor 22 and hence taking of a fingerprint image would be started from a position that is deviated from the center of the bulb 102 of the finger 100 toward the tip portion 101 side rather than from the center of the bulb 102. In other words, most of the portion that is necessary for fingerprint authentication (i.e., the portion from which feature points of a fingerprint can be extracted) would not pass over the fingerprint sensor 22. It is highly probable that the taking of a fingerprint image fails.

In contrast, where the finger detecting member 25 is disposed on the rear of the fingerprint sensor 22 as in the case of the embodiment, retuning from a suspended state is started after the finger detecting member 25 detects a finger. Therefore, an event does not occur that taking of a fingerprint image is started from a position that is deviated from the center of the bulb 102 of the finger 100 toward the tip portion 101 side. That is, in the embodiment, taking of a fingerprint image is started from a position that is deviated from the first joint 103 of the finger 100 toward the bulb 102 side. Therefore, the probability that taking of feature points of a fingerprint that are necessary for fingerprint authentication results in a failure is low. As a result, the embodiment can realize power saving and increase the fingerprint registration ratio and the fingerprint authentication success ratio.

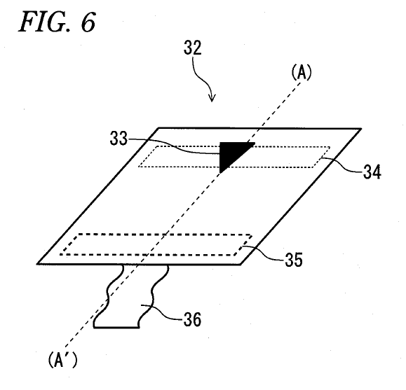

Next, a modification to the embodiment will be described with reference to FIG. 6. FIG. 6 shows an appearance of a film-type fingerprint sensor 32 as a modification to the embodiment. The film-type fingerprint sensor 32 is connected to the printed circuit board 30 by a flat cable 36. As shown in FIG. 6, a finger detecting member 34 and a fingerprint image sensor 35 are formed on a long and narrow film so as to be spaced from each other by a certain distance and electrically connected to each other. The certain distance is about 1 cm, which is an average distance between the center of the bulb and the first joint of a finger. A finger position mark 33 is formed on the finger detecting member 34 to cause the user whose intends to do fingerprint authentication to place the bulb 102 of his or her finger 100 on the finger position mark 33.

When a finger 100 touches the finger position mark 33, the finger detecting member 34 detects a potential variation and outputs a detection result to the fingerprint image sensor 35. Upon receiving the detection result from the finger detecting member 34, the fingerprint image sensor 35 starts taking a fingerprint image. When the bulb 102 of the finger 100 is placed on the finger position mark 33, the first joint 103 of the finger 100 is located over the fingerprint image sensor 35. Since the fingerprint image sensor 35 starts taking a fingerprint image from the first joint 103, it can take a fingerprint image of the entire portion, located on the tip side of the first joint 103, of the finger 100.

While certain embodiments have been described, these embodiments have been presented by way of example only, and are not intended to limit the scope of the invention. Indeed, the novel apparatus described herein may be embodied in a variety of other forms; furthermore, various omissions, substitutions and changes in the form of the apparatus, described herein may be made without departing from the sprit of the invention. The accompanying claims and their equivalents are intended to cover such forms or modifications as would fall within the scope and sprit of the invention.

What is claimed is:

1. An information processing apparatus comprising:
a housing;
a fingerprint sensor in a top surface of the housing and configured to record a fingerprint image;
a finger detecting module spaced from the fingerprint sensor and configured to detect a finger;
an authenticating module configured to cause the fingerprint sensor to record a fingerprint image when the finger detecting module detects a finger, and configured to determine whether authentication has succeeded or failed based on fingerprint data obtained from the fingerprint image; and
an activating module configured to activate the information processing apparatus when the authenticating module determines that the authentication has succeeded.

2. The apparatus of claim 1, wherein the fingerprint sensor is closer to an end portion of the top surface than the finger detecting module.

3. The apparatus of claim 1 further comprising:
a display unit connected to the housing by a hinge,
wherein the finger detecting module is closer to the hinge than the fingerprint sensor.

4. The apparatus of claim 1, wherein the top surface includes a mark substantially at a position where the finger detecting module is disposed.

5. The apparatus of claim 1, wherein the finger detecting module is configured to detect a finger based on a potential variation on the top surface.

6. The apparatus of claim 1, wherein the finger detecting module comprises a light-emitting unit configured to emit light outside the housing.

7. The apparatus of claim 6, wherein the light-emitting unit is configured to light according to an authentication result of the authenticating module.
